(19) United States
(12) Patent Application Publication
(10) Pub. No.: US 2014/0050533 A1
(43) Pub. Date: Feb. 20, 2014

(54) SNAKE ADAPTOR FOR LOCATION OF A PRESSURIZED GAS LINE

(71) Applicants: Tom Lennon, Hewitt, NJ (US); Christen J. Brown, Middletown, NY (US); Estevan Bezares, Bronx, NY (US)

(72) Inventors: Tom Lennon, Hewitt, NJ (US); Christen J. Brown, Middletown, NY (US); Estevan Bezares, Bronx, NY (US)

(21) Appl. No.: 13/588,713

(22) Filed: Aug. 17, 2012

(51) Int. Cl. F16L 101/30; G01B 5/04

(52) U.S. Cl. 405/183.5; 33/751

(57) ABSTRACT

Adaptors for use with snakes/adaptors locating offsets or main lines in pressurized natural gas systems and methods of making/using the adaptors are described. The snake adaptors contain a stub pipe, a fitting, a bushing, and a cap compressing the bushing around a snake, forming an air-tight fit between the bushing and cap and between the bushing and snake. The snake adaptors help locate a gas main by closing the gas valve, attaching an adaptor to the gas valve, opening the gas valve, and extending a snake through the adaptor and gas valve until an end of the snake contacts the gas main. The position of the snake within the adaptor is marked when the end of the snake contacts the gas main, the snake is removed from the valve, and the marked position then used to determine the location of the gas main. Other embodiments are described.

### FIELD

This application relates generally to location of underground utilities. More specifically, this application relates to systems and methods for locating a buried gas main distribution line from a service valve without depressurizing the gas line.

### BACKGROUND

Natural gas distribution has become one of the most important utilities and a key provider for heat around the world. Maintenance and repair of natural gas (or gas) lines can be very important due to the danger of gas leaks and the critical importance to customers of natural gas in continued supply for many uses, such as cooking, air heating, use by water heaters, clothes dryers, etc.

Most gas lines are buried along streets that also include other utilities. Often, to repair a damaged or clogged gas line, such as a gas main or branch, a hole must be excavated and the pipe checked or replaced. Currently, the technology to determine the exact locations of the gas mains, especially at elevated pressures, in the most confident manner does not exist. Some technicians are trained to approximate where the gas lines are and provide mark outs on the ground where the gas line should be. The mark outs, even when provided, are based upon map accuracy and the expertise of a mark out technician. The technician often picks up other utilities normally running alongside gas mains, which the gas repair crews do not want to disturb. Often, errors in the mark outs can still be off by as much as 3 to 4 feet, which causes extra time and effort in excavation and avoiding other utilities, along with added costs in repairing roads and service delays.

Currently, one effective method to avoid losses and delays is for the gas mechanic to determine exactly where the main is located and then proceed with digging with a high confidence level. In general this is done by closing a curb valve, cutting a service pipe to a customer at the curb line which is a known point, opening the valve and then inserting a snake, such as a fiberglass or metal snake, to determine the distance to the offset or main. A rag or something else is sometimes placed in the service pipe to reduce gas leakage into the atmosphere. The measurement from the snake is then transferred to the pavement, and a mark at that location is where the digging can commence. This action can be performed without the need for a special tool in a low pressure. While this practice is accurate and a time saver for mis-marked mains and offset(s), it can only be done on low pressure systems, and even with then, natural gas is leaked into the air. In some places, governmental regulations restrict the amount of natural gas that can be vented without penalty.

### SUMMARY

This application describes adaptors for use with snakes (or snake adaptors) in finding location of offsets or main lines in pressurized natural gas systems and methods of making and using the adaptors. The snake adaptors may include a stub pipe, a fitting, a bushing, and a cap configured to compress the bushing around a snake to form an air-tight fit between the bushing and the cap and between the bushing and the snake. The snake adaptors may be used in locating a gas main by, closing the gas valve, attaching an adaptor to the gas valve, opening the gas valve, and extending a snake through the adaptor and gas valve until an end of the snake contacts the gas main. The position of the snake within the adaptor may be marked when the end of the snake contacts the gas main, the snake removed from the valve, and the marked position then used to determine the location of the gas main.

### BRIEF DESCRIPTION OF THE DRAWINGS

The following description can be better understood in light of the Figures, in which:

FIG. 1 shows an exploded view of some embodiments of a snake adaptor for gas lines;

FIG. 2 shows some embodiments of an exemplary snake adaptor for gas lines;

FIG. 3 shows a cross-sectional view of some embodiments of the snake adaptor of FIG. 2;

FIG. 4 shows some embodiments of a coiled snake with an exemplary snake adaptor;

FIG. 5 shows a schematic view of some embodiments of a service valve and stub to a gas main;

FIG. 6 is a schematic view of some embodiments of a service valve and stub to gas main with an exemplary snake adaptor in use;

FIG. 7 shows a schematic view of some embodiments of a service valve and stub to a gas main;

FIG. 8 depicts a schematic view of some embodiments of a service valve and stub to gas main with an exemplary snake adaptor in use; and

FIG. 9 shows some embodiments of an exemplary snake adaptor and snake being used to mark the location of a gas main.

The Figures illustrate specific aspects of the snake adaptors for use with gas lines and methods for making and using such devices. Together with the following description, the Figures demonstrate and explain the principles of the methods and structures produced through these methods. In the drawings, the thickness of layers and regions are exaggerated for clarity. The same reference numerals in different drawings represent the same element, and thus their descriptions will not be repeated. As the terms on, attached to, or coupled to are used herein, one object (e.g., a material, a layer, a substrate, etc.) can be on, attached to, or coupled to another object regardless of whether the one object is directly on, attached, or coupled to the other object or there are one or more intervening objects between the one object and the other object. Also, directions (e.g., above, below, top, bottom, side, up, down, under, over, upper, lower, horizontal, vertical, “x,” “y,” “z,” etc.), if provided, are relative and provided solely by way of example and for ease of illustration and discussion and not by way of limitation. In addition, where reference is made to a list of elements (e.g., elements a, b, c), such reference is intended to include any one of the listed elements by itself, any combination of less than all of the listed elements, and/or a combination of all of the listed elements.

### DETAILED DESCRIPTION

The following description supplies specific details in order to provide a thorough understanding. Nevertheless, the skilled artisan would understand that the described snake adaptors for use with gas lines and methods of making and using the snake adaptors can be implemented and used without employing these specific details. Indeed, the snake adaptor can be placed into practice by modifying the illustrated devices and methods and can be used in conjunction with any other apparatus and techniques conventionally used in the industry. For example, while the description below focuses on methods of finding buried gas mains and offsets, the snake adaptor may be used to locate branches and offsets in walls, under floors, and otherwise in structures or otherwise hidden or inaccessible locations for gas lines.

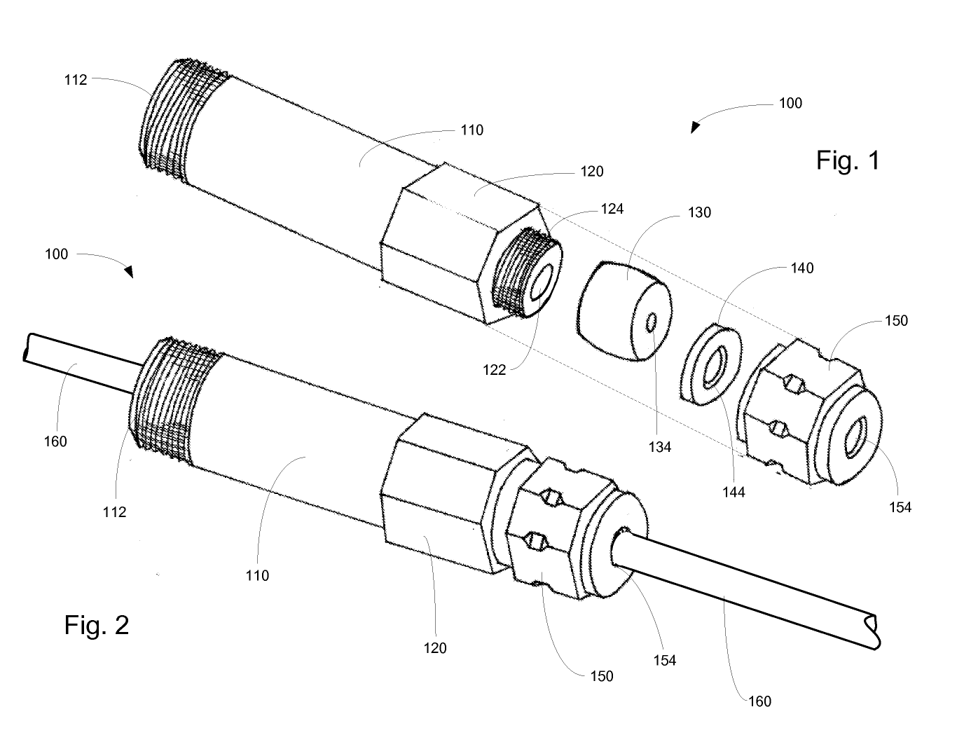

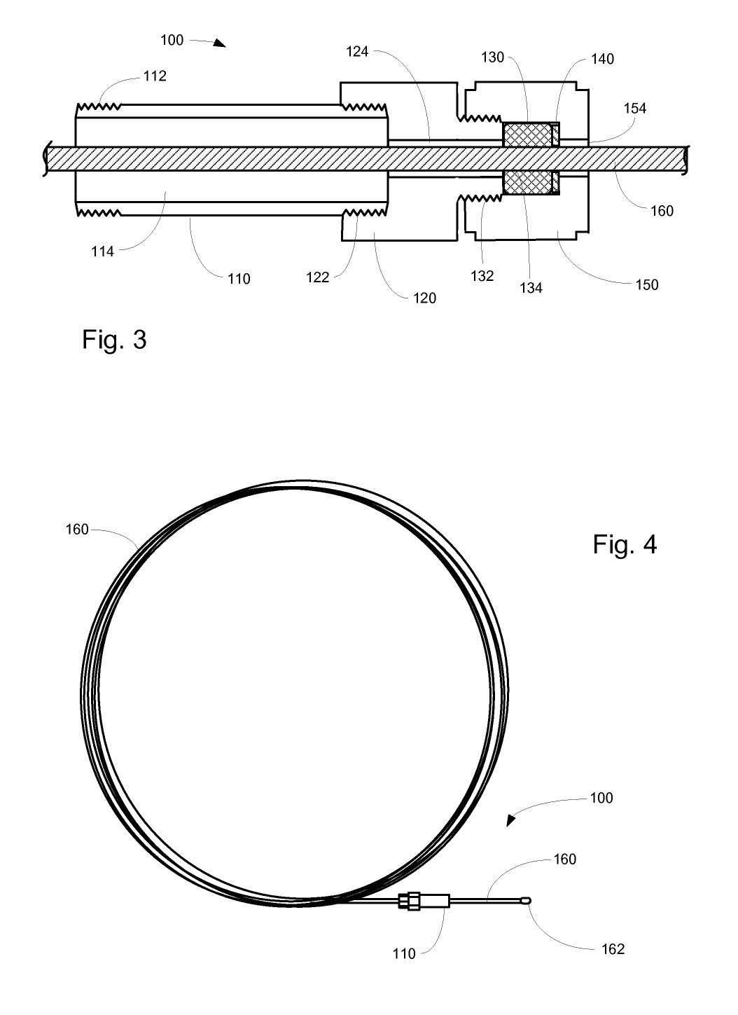

Some embodiments of snake adaptors for use with gas lines and associated methods of making and using these devices are described herein and illustrated in the Figures. FIGS. 1-3 illustrate some embodiments of a snake adaptor 100. The snake adaptor 100 may include a stub (or stub pipe) 110, fitting 120, bushing 130, washer 140, and cap 150. The snake adaptor 1000 may be used in some configurations with a snake 160.

As shown in FIG. 1, the stub pipe 110 (or nipple) of the snake adaptor 100 may comprise any standard pipe that may be attached to a gas valve or other fitting (such as a coupling) in a gas system. The stub 110 may be configured to be used in attaching snake adaptor 100 to any desired gas system that contains threads 112 (or any other connection method). For example, the stub 110 may be a standard black or galvanized metal pipe with a diameter of between ½″ and 2″, and with a length of between about 3 and 18 inches (or any desired or useful length). In some embodiments, the stub pipe 110 may be PVC or other material suitable for only a temporary use with a gas system.

The fitting 120 of the snake adaptor 100 may be coupled (or otherwise connected) to an end of the stub pipe 110. In some embodiments, it may be coupled with a threaded coupling 122. The fitting 120 may include a narrow channel 124 having an internal diameter slightly larger than the diameter of the snake 160 to be used with the snake adaptor 100. For example, the narrow channel 124 may have a diameter of 5/16″ for use with a ¼″ diameter snake 160. The fitting 120 may also included a threaded portion 132 for connection with the cap 150.

The bushing 130 of the snake adaptor 100 may be located between and largely within the cap 150 and located between the washer 140 and the fitting 120. The bushing 130 may be formed of a resilient material such as rubber, neoprene, or other suitable material. The bushing 130 may have a channel 132 through which the snake 160 may pass when in use. The channel 132 of bushing 130 may have a diameter the same as or slightly smaller than the diameter of the snake 160. For example, for a snake 160 having a ¼″ diameter, the channel 132 of bushing 130 may be ¼″ or less such that the snake 160 would have a fairly tight fit with the busing 130.

The washer 140 of the snake adaptor 100 may fit within the nut of cap 150 and have an internal diameter slightly larger than the diameter of the snake 160. For example, the internal diameter of the washer 140 may be about 5/16″ for a snake 160 with a ¼″ diameter, similar to the size of the channel 124 of the fitting 120. The washer 140 may be formed of metal or any other material. For example, the washer 140 may be a standard washer used in the industry. The washer 140 may function to form a stop against which the bushing 130 is compressed, and may also function to allow cap 150 to rotate more easily without twisting or damaging the bushing 130 when the cap 150 is tightened.

As shown in FIG. 1, the snake adaptor 100 contains a cap 150. The nut of the cap 150 may include hole 154. The hole 154 may be larger than the diameter of the snake 160, but smaller than an outer diameter of the washer 140. The nut of the cap 150 may be formed of metal or any other suitable material. The nut 150 may be tightened against the fitting 120 to tighten the grip of the bushing against the snake 160. The nut 150 may be adjusted for tightness depending on how much effort is desired to move the snake 160 through a gas system as described herein, as well as depending on the pressure required to prevent leakage of gas when the snake adaptor is in use with a pressurized gas system.

In use, as nut 150 is tightened onto the fitting 120, the bushing 130 may be compressed between the washer 140 and the fitting 120, thereby forming an air-tight fit around the snake 160. The air-tight fit between the snake 160 and the bushing 130, along with the compression of the bushing 130 within the nut 150, may reduce or eliminate gas leakage through snake adaptor 100 when in use, while still allowing the snake 160 to be fed into the gas system as described herein. This air-tight fit may be robust enough that the snake adaptor 100 may be used with pressurized gas systems, including high-pressure gas systems, thereby reducing any interruption in service for that system, reducing gas leakage, and providing a highly accurate method for finding the position of a gas main or offset.

In the embodiments shown in FIG. 4, the snake 160 may be a fiberglass snake that can be coiled for use with electrical, gas, and plumbing systems. The snake 160 may be formed of any material and/or may be any snake and/or fish tape used in the industry. The snake 100 may include an end 162 in some configurations. The end 162 may be any snake end used in the industry, such as a metal cap, eyelet, coil, etc. The snake adaptor 100 may be attached to the snake 160 and left on for repeated and easy use in subsequent jobs, or the adaptor 100 may be removed from snake 160 each time it is used.

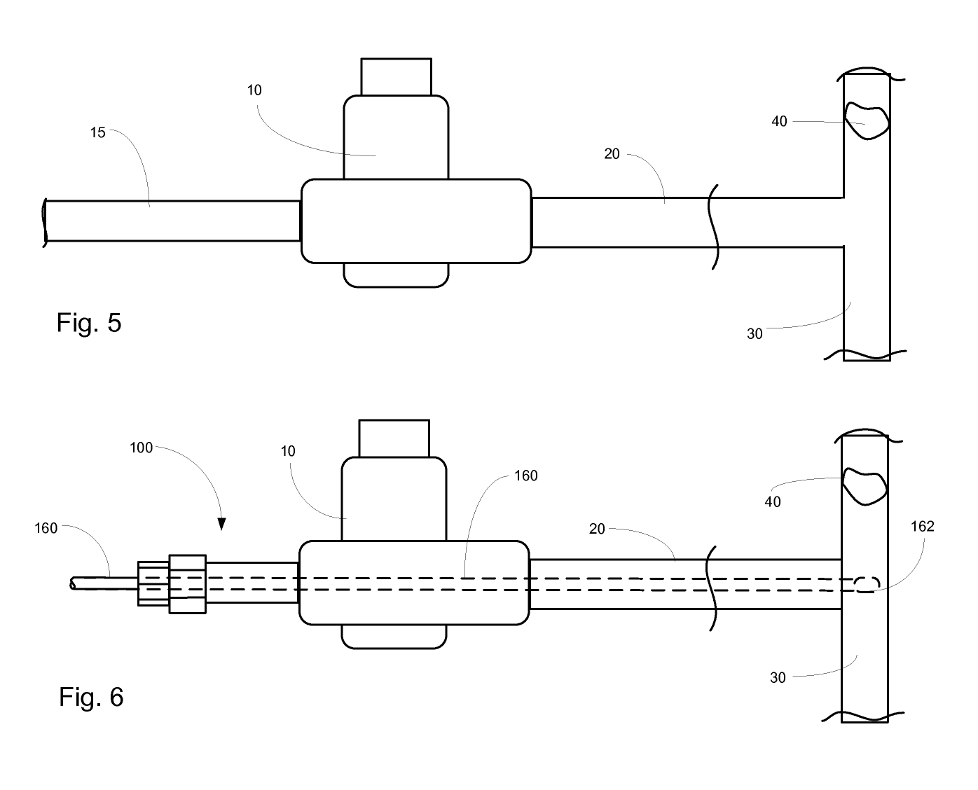

FIGS. 5 and 6 illustrate some methods and systems in which the snake adaptor 100 may be used. In these methods and systems, a valve 10 may be connected to a connection pipe 20 and attached to a gas main 30. The valve 10 may connect a service pipe 15 to a gas system and gas main 30. In the embodiments depicted in these Figures, a blockage 40 is illustrated in gas main 30.

To use the snake adaptor 100 to determine the distance to the gas main 30, the valve 10 may be closed and the service pipe 15 cut or disconnected from the valve 10. The pipe stub 110 of the adaptor 100 may then be attached to the valve 10. The connection between the pipe stub 110 and the valve 10 may be accomplished by screwing the threads 112 of the pipe stub 110 into a threaded opening in the valve 10 where the service pipe 15 was previously attached. Of course, the attachment between the pipe stub 110 and the valve 10 may be sealed with PTFE tape, thread compound, or other sealant to prevent leakage. Similarly, the connection between the other components of the snake adaptor 100 may also be similarly sealed against leakage.

Once the snake adaptor 100 is connected in place with the valve 10, the valve 10 may be opened and the snake 160 may be advanced through the open valve 10 and into the connection pipe 20 until the end 162 contacts a blockage or the gas main 30. Once the snake 160 cannot be advanced any further, the position on the snake 160 where the snake interfaces with the snake adaptor 100 may be marked, noting the position of the snake 160 within the gas system. During this phase, the snake adaptor 100 may prevent gas leakage without the necessity of turning off the gas in gas main 30 as the bushing 130 of the adaptor effectively seals against gas leakage.

The snake 160 may then be withdrawn from the connection pipe 20 and through the valve 10. The valve 10 may then be closed again. The snake 160 may be removed from the snake adaptor 100 or the snake adaptor 100 may be removed from the valve 10. The snake 160 may then be used to measure the distance to the gas main 30 or to a blockage in the connection pipe 20.

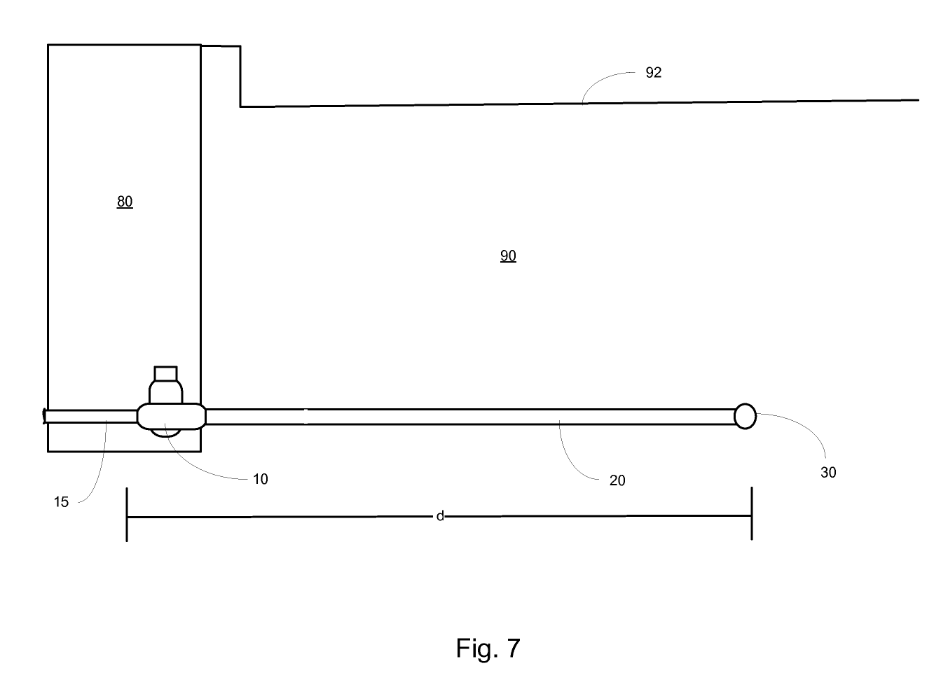

FIGS. 7-9 illustrate some embodiments of using the snake adaptor 160 to measure the distance d between the valve 10 and the gas main 30 underground 90 and under a street 92. In these embodiments, the valve 10 may attach a service pipe 15 to a gas main 30 through a connection pipe 20. The valve 10 may be accessible through an access hole 80. The access hole 80 may be an existing access or may be an enlarged access due to an excavation around the valve 10. The location of the gas main 30 may be located by first closing the valve 10. The service pipe 15 may then be cut and removed from (or otherwise disconnected) from the valve 10. The snake adaptor 100 may then be attached to the valve 10 in a similar manner as described above.

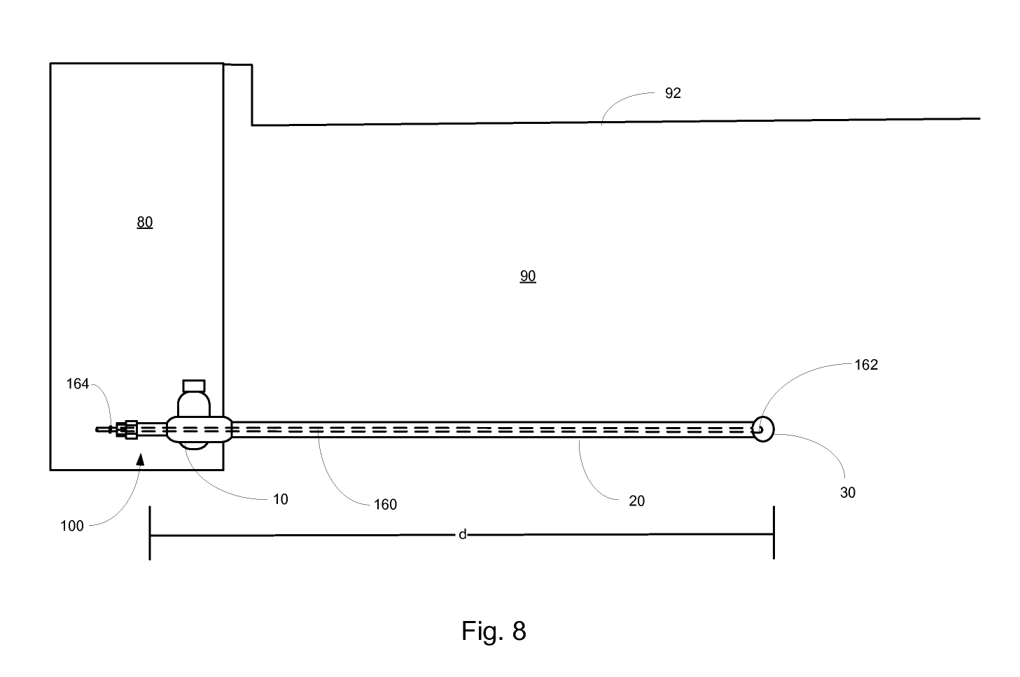

As shown in FIG. 8, once the snake adaptor 100 is connected in place with the valve 10, the valve 10 may be opened without fear of leakage and the snake 160 may be advanced through the open valve 10 and into the connection pipe 20 until the end 162 contacts the gas main 30. Once the snake 160 cannot be advanced any further, the position on the snake 160 where it interfaces with the snake adaptor 100 may be marked with a mark 164, noting the position of the snake 160 within the gas system.

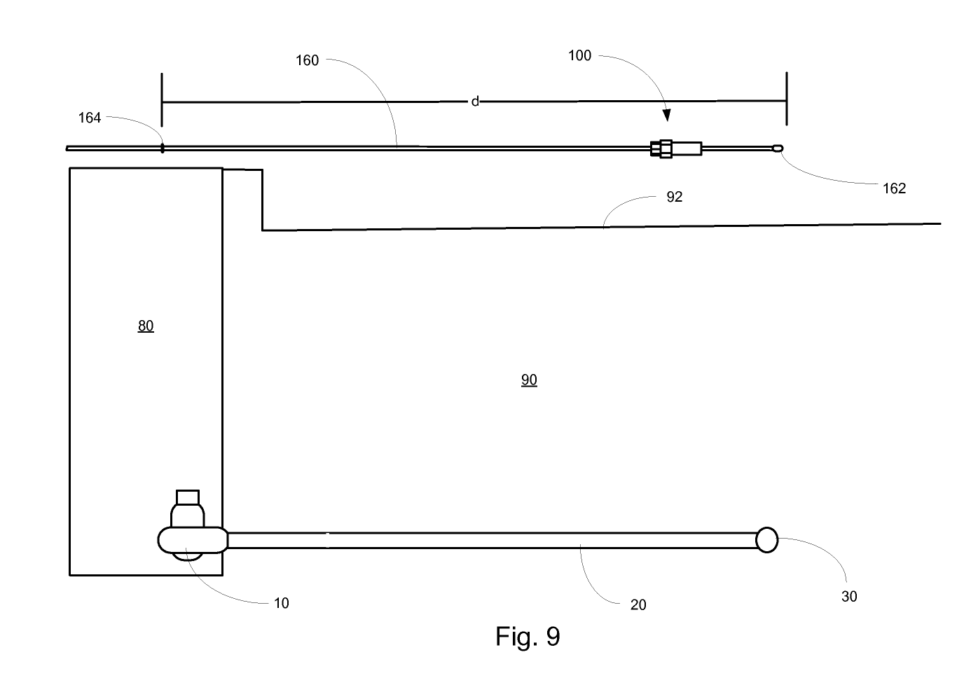

As shown in FIG. 9, the snake 160 may then be withdrawn from the connection pipe 20 and the valve 10 and the valve may then be closed. The snake adaptor 100 may then be removed from the valve 10. The snake 160 may be laid out on the street 92, holding the mark 164 over the position where the snake 160 was in the gas system and the end 162 was contacting the gas main 30. The location of the gas main 30 may then be marked on the street 92, indicating where to dig to locate the gas main with minimum risk to hitting other utilities and minimizing damage to the street 92.

By using the snake adaptor 100, financial loss to the gas company, interruptions to gas service, and potential environmental damage and other damage risks (such as by explosion) may be significantly reduced or eliminated by allowing the gas to remain on while locating the gas main without significant leakage. The snake adaptor 100 may provide a simple, cost-effective tool to improve accuracy in repair and maintenance, as well as reduced costs through reduced service interruption and reduced time required to for repair or maintenance.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation, and use may be made without departing from the principles and concepts set forth herein. Also, as used herein, the examples and embodiments, in all respects, are meant to be illustrative only and should not be construed to be limiting in any manner.

1. A snake adaptor, comprising:
a stub pipe;
a fitting;
a bushing; and
a cap configured to compress the bushing around a snake to form an air-tight fit between the bushing and the cap and between the bushing and the snake.

2. The adaptor of claim 1, wherein the stub pipe comprises a threaded connection for connection with a gas supply valve.

3. The adaptor of claim 1, wherein bushing comprises a compliant material.

4. The adaptor of claim 1, further comprising a washer disposed between the cap and the bushing.

5. The adaptor of claim 1, wherein the cap is configured to be threadedly connected to the fitting.

6. The adaptor of claim 5, wherein the adaptor is configured such that an internal channel is formed extending through the adaptor from the cap through the stub pipe.

7. The adaptor of claim 6, wherein the adaptor is configured such that the snake is movable within the adaptor without breaking the air-tight fit.

8. The adaptor of claim 1, wherein the snake comprises a flexible fiberglass rod.

9. A snake adaptor, comprising:
a fitting configured to be connected to a gas valve;
a bushing;
a washer; and
a cap configured to compress the bushing between the washer and the fitting, and compressing the bushing around a snake to form an air-tight fit between the bushing and the cap and between the bushing and the snake.

10. A method of locating a gas main, comprising:
closing a gas valve;
attaching an adaptor to the gas valve;
opening the gas valve;
extending a snake through the adaptor and gas valve until an end of the snake contacts the gas main.

11. The method of claim 10, wherein the gas main has pressurized natural gas therein.

12. The method of claim 10, wherein the snake comprises a flexible fiberglass rod.

13. The method of claim 10, wherein the adaptor comprises:
a stub pipe configured to connect to the valve;
a fitting;
a bushing; and
a cap configured to compress the bushing around the snake to form an air-tight fit between the bushing and the cap and between the bushing and the snake.

14. The method of claim 13, wherein the air-tight fit is not broken during the extending.

15. The method of claim 13, wherein the bushing comprises a compliant material.

16. The method of claim 10, further comprising marking a position of the snake within the adaptor when the end of the snake contacts the gas main.

17. The method of claim 16, further comprising removing the snake from the valve.

18. The method of claim 17, further comprising using the marked position to determine the location of the gas main.

19. The method of claim 18, wherein the gas main is buried underground.
